(19) United States
(12) Patent Application Publication
(10) Pub. No.: US 2026/0149526 A1
(43) Pub. Date: May 28, 2026

(54) Selectively Mapping of Bit Streams Across Each of a Plurality of Optical Fibers

(71) Applicant: Cspeed Inc., Palo Alto, CA (US)

(72) Inventors: Steven Michael Gemelos, San Jose, CA (US); Loukas Paraschis, Menlo Park, CA (US); Stefanos Sidiropoulos, Palo Alto, CA (US); Sanjai Kohli, Los Altos Hills, CA (US)

(73) Assignee: Cspeed Inc., Palo Alto, CA (US)

(21) Appl. No.: 19/376,392

(22) Filed: Oct. 31, 2025

Related U.S. Application Data
(60) Provisional application No. 63/724,967, filed on Nov. 26, 2024.

(51) Int. Cl. H04J 14/02

(52) U.S. Cl. CPC H04J 14/0228; H04J 14/0212; H04J 14/02862

(57) ABSTRACT

Apparatuses, methods, and systems for optical transmission are disclosed. One optical transmission system includes a plurality of wave-division-multiplexing (WDM) transceivers, each of the WDM transceivers, wherein an output of each of the plurality of WDM transceivers is transmitted over a corresponding one of the optical fibers, a plurality of bit source devices, each of the plurality of bit source devices generating a plurality of bit streams, wherein each of the plurality of bit streams of each of the bit sources is selectively connected to an input of one of the plurality of WDMs for communication across a corresponding one of the optical fibers, wherein at least one of the bit streams of one of the plurality of bit source devices is communicated across a different one of the optical fibers than another one of the bits streams of the one of the plurality of bit source devices.

### RELATED PATENT APPLICATIONS

This patent application claims priority to U.S. Provisional Patent Application Ser. No. 63/724,967 filed Nov. 26, 2024, which is herein incorporated by reference.

### FIELD OF THE DESCRIBED EMBODIMENTS

The described embodiments relate generally to optical communications. More particularly, the embodiments described relate to systems, methods, and apparatuses for mapping bit streams across each of a plurality of optical fibers.

### BACKGROUND

Much of cloud-based infrastructure is based on storage and processing of data by large numbers of servers in data centers. These servers are connected through a switch network in various configurations. Data centers increasingly rely on interconnects for delivering critical communications connectivity among numerous servers, memory, and computation resources. Data center interconnects have turned to optical communications, and the recent acceleration in data center requirements is expected to further drive optical interconnect technologies deeper into the systems architecture.

Data centers typically include large number of optical fibers interconnecting devices. The rapid increases in processing and devices have greatly increased the number of interconnections between the devices.

It is desirable to have methods, apparatuses, and systems for mapping bit streams across each of a plurality of optical fibers.

### SUMMARY

An embodiment includes an optical communication system. The optical transmission system includes a plurality of wave-division-multiplexing (WDM) transceivers, each of the WDM transceivers comprising a plurality N lasers, each of the N lasers configured to generate an optical communication signal having a carrier optical frequency within a corresponding channel that is different than a carrier optical frequency and corresponding channel of each of other N-1 different lasers of the N lasers, wherein each of the plurality of WDM transceivers is coupled to one of Y optical fibers, wherein an output of each of the plurality of WDM transceivers is transmitted over a corresponding one of the Y optical fibers when the corresponding one of the Y optical fibers is operational, a plurality of bit source devices, each of the plurality of bit source devices generating a plurality of bit streams, wherein each of the plurality of bit streams of each of the bit sources is selectively connected to an input of one of the plurality of WDMs and modulated onto a one of the N carriers signals of the one of the plurality of WDMs for communication across a corresponding one of the Y optical fibers, wherein at least one of the bit streams of one of the plurality of bit source devices is communicated across a different one of the Y optical fibers than another one of the bits streams of the one of the plurality of bit source devices.

Another embodiment includes a method of an optical communication system. The method includes generating, by each of N lasers of each of a plurality of wave-division-multiplexing (WDM) transceivers of an optical transmission system, an optical communication signal having a carrier optical frequency within a corresponding channel that is different than a carrier optical frequency and corresponding channel of each of other N-1 different lasers of the N lasers, coupling each of the plurality of WDM transceivers to one of Y optical fibers, wherein an output of each of the Y WDMs is transmitted over a corresponding one of the Y optical fibers when the corresponding one of the Y optical fibers is operational, receiving, by each of modulators of the WDM transceivers, N bit streams of a plurality of input streams, modulating, by each of modulators, the optical communication signal of each of the N lasers with corresponding N bit streams, receiving, by a reconfigurable switch, the plurality input bit streams, generating, by each of a plurality of bit source devices, a plurality of bit streams, and selectively connecting each of the plurality of bit streams of each of the bit sources to an input of one of the plurality of WDMs for modulation onto the N carriers signals of the one of the plurality of WDMs for communication across a corresponding one of the Y optical fibers, wherein at least one of the bit streams of one of the plurality of bit source devices is communicated across a different one of the Y optical fibers than another one of the bits streams of the one of the plurality of bit source devices.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an optical transceiver system, according to an embodiment.

FIG. 2 shows an optical transceiver system, according to another embodiment.

FIG. 3 shows an optical transceiver system, according to another embodiment.

FIG. 4 shows an optical transmitter system, according to another embodiment.

FIG. 5 shows an optical transmitter system that includes an optical cross connect system, according to another embodiment.

FIG. 6 shows an optical transmitter system, according to another embodiment.

FIG. 7 shows an optical transmitter system, according to another embodiment.

FIG. 8 shows an optical transmitter system, according to another embodiment.

FIG. 9 shows an optical transmitter system that includes both first and second reconfigurable switches, according to another embodiment.

FIG. 10 is a flow chart that includes steps of a method of mapping bit streams across each of a plurality of optical fibers, according to an embodiment.

FIG. 11 shows an optical transmitter system, according to an embodiment.

FIG. 12 shows passband filtering of each carrier signal of an optical transmitter system, according to an embodiment.

FIG. 13 is a frequency spectrum of carrier signals of the optical transmitter system, according to an embodiment.

FIG. 14 shows power curves of a laser, according to an embodiment.

FIG. 15 shows a frequency spectrum of carrier signals of the optical transmitter system in which carrier signals are selected to reduce inter-channel interference, according to an embodiment.

FIG. 16 is a flow chart that includes steps of a method of an optical transmitter system, according to an embodiment.

FIG. 17 shows a pair of laser transceivers, according to an embodiment.

### DETAILED DESCRIPTION

The embodiments described include methods, apparatuses, and systems for an optical communication system. The embodiments described provide for selecting electric connections between one or more sources of streams of bits and wave division multiplexers (WDMs) for optical communication over a plurality of optical fibers to an optical receiver. For an embodiment, the mapping is provided by a reconfigurable switch. For an embodiment, a controller utilizes the reconfigurable switch to complete the selective electronic connections. Accordingly, the optical fiber connections can be monitored and the selective electrical connections updated based on the monitoring. Limited performance or failures of the optical fibers can be avoided or mitigated by selecting the electric connections over time.

Data centers have evolved with Clos topology to address scalability, reliability, and cost efficiency. Initially built with smaller, low-radix (fewer connections) multi-stage Clos networks (tall, not wide). The Clos topology is used to create a high-capacity, low-latency network. It consists of multiple switch layers including layers of leaf switches and spine switches. The leaf switches are access switches that directly connect to servers, storage devices, and other endpoints within a single rack. The leaf switches are often called Top-of-Rack (ToR) switches. The spine switches form the core of the network, connecting every leaf switch to every other leaf switch. The spine switches do not connect to servers or to each other.

The advancements of artificial intelligence (AI) are increasing workloads, and the use of the Clos topology has evolved. Generally, AI needs more bandwidth, low latency, high reliability, and any-to-any pattern (east-west traffic versus north-south). In order to reduce latency and increase bandwidth, the Clos topology has been flattened (fat wide clos), requiring fewer stages and many more connections (high radix).

For some implementations the data center radix has gone from ˜64 to ˜256+ connections per switch. As the number of connections between switches increases (x), the number of interconnects explodes super-linearly by x\hat{ }2. Due to the large number of interconnections, 10% of data center outages are fiber/cable related and will get worse due to the super-linearity as the number of interconnections grows.

The utilization of wave division multiplexing (WDM) provides a great opportunity to reduce the number of interconnections by aggregating more “connections” over a single fiber/cable through multiple carrier signals. However, WDM utilization goes against the desired “high radix” topology for AI data centers. At least some of the described embodiments include a mapping of data links to WDM channels which can allow for a high effective radix. Therefore, the described embodiments that include the mapping (which for some embodiments is adaptive and change over time) provide the benefits of a high radix but drastically reduces the number of fiber/cable connections (x\hat{ }2 reduction). The described embodiments for mapping can be statically implemented, for example, by conductive traces on a printed circuit board (PCB), or more effectively with a reconfigurable switch. The mapping includes or defines the selective electrical connections between the bit streams of the bit stream sources and the WDMs, which determines which optical fiber each of the bit streams are communicated across.

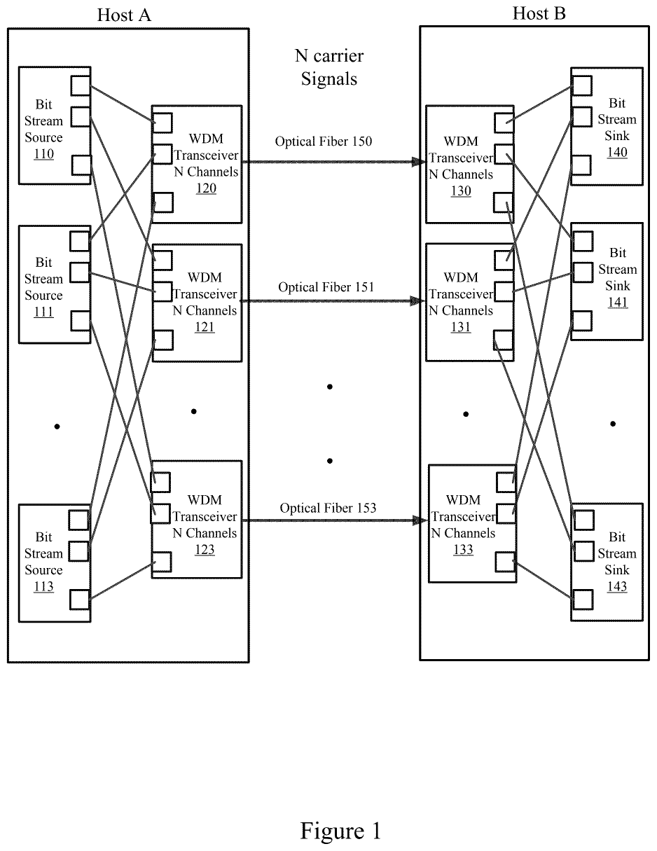

FIG. 1 shows an optical transceiver system, according to an embodiment. As shown, a host A transceiver communicates through optical fibers 150, 151, 153 with a host B transceiver. For an embodiment, the host A includes a plurality of WDM transceivers 120, 121, 123 which receive data bit streams from a plurality of bit stream devices 110, 111, 113. For an embodiment, each output of each of the bit stream devices 110, 111, 113 includes a stream of data bits that are each selectively connected to an input of one of the WDM transceivers 120, 121, 123 for communication over the optical fibers 150, 151, 153 to the host B. For an embodiment, at least one stream of data bits output from one of the bit stream sources is communicated over a different one of the optical fibers 150, 151, 153 than a different of the stream of data bits of the bit stream source. For example, for an embodiment, the optical fiber 150 carries a WDM signal that includes a plurality of carrier signals. Further, for an embodiment, the optical fiber 151 carries another WDM signal that also includes a plurality of carrier signals. As shown, the bit stream source 110 provides streams of data bits to both the WDM transceiver 120 and the WDM transceiver 121. Accordingly, one of the streams of data bits is modulated on a carrier signal of the WDM transceiver 120 and communicated over the optical fiber 150, and another of the stream of bits is modulated on a carrier signal of the WDM transceiver 121 and communicated over the optical fiber 151.

Further, as shown, host B includes a plurality of transceivers 130, 131, 133 that receive and demodulate the streams of data bits communicated across the optical fibers 150, 151, 153. Further, for an embodiment, the streams of data bits output from the plurality of WDM transceivers 130, 131, 133 are selectively connected to bit stream sinks 140, 141, 143. For an embodiment, the selective connections between the bit stream devices 110, 111, 113 and the WDM transceivers 120, 121, 123 and between the WDM transceivers 130, 131, 133 and the bit stream sinks 140, 141, 143 are such that the bit stream devices 110, 111, 113 are virtually connected to the bit stream sinks 140, 141, 143.

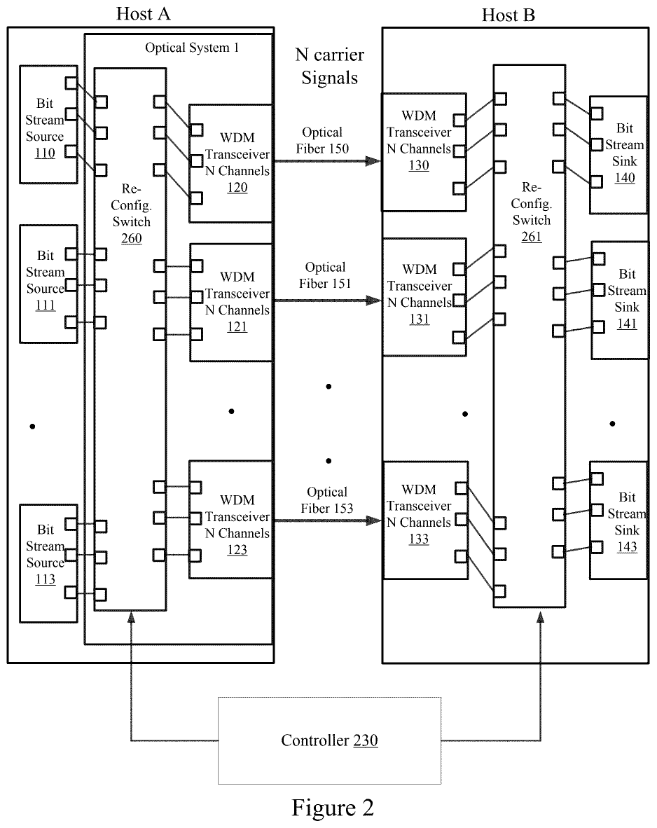

FIG. 2 shows an optical transceiver system, according to another embodiment. As shown, for this embodiment, the host A further includes a reconfigurable switch 260, and the host B includes a reconfigurable switch 261. The inclusion of the reconfigurable switch 260 allows the selective connections between the bit stream devices 110, 111, 113 and the WDM transceivers 120, 121, 123 to change over time. That is, a controller 230 connected to the reconfigurable switch 260 can update the selective connections. Further, as shown, the inclusion of the reconfigurable switch 261 allows the selective connections between the WDM transceivers 130, 131, 133 and the bit stream sinks 140, 141, 143 to change over time. That is, a controller 230 connected to the reconfigurable switch 261 can update or change the selective connections over time.

For at least some embodiments, the selective connections of the reconfigurable switch 260 and the reconfigurable switch 261 can be used to adaptively avoid using optical fibers that have failed or are deteriorating in performance. Further, as will be described, selective connections of the reconfigurable switch 260 and the reconfigurable switch 261 can be used to avoid the use of specific lasers within the WDM transceivers 120, 121, 123, 130, 131, 133.

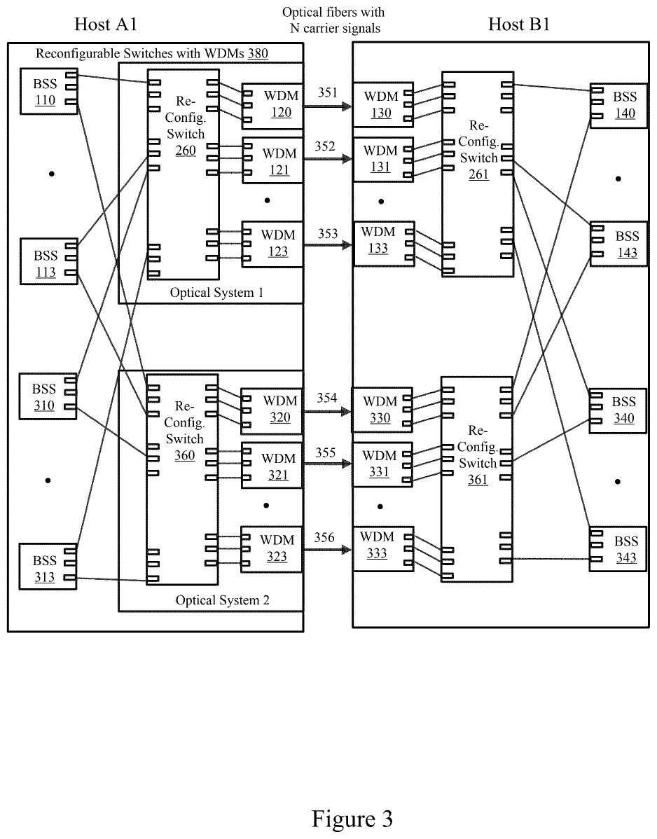

FIG. 3 shows an optical transceiver system, according to another embodiment. FIG. 3 depicts that any output of each of bit stream sources 110, 113, 310, 313 can be electrically connected to any of inputs of reconfigurable switches 260, 360. The reconfigurable switches 260, 360 then selectively connects each of the inputs of the reconfigurable switches 260, 360 to an input of WDMS 120, 121, 123, 320, 321, 323. As shown, different bit streams of each of the bit stream sources 110, 113, 310, 313 can be connected to different reconfigurable switches 260, 360. For example, a first bit stream of the bit stream source 110 may be connected to the reconfigurable switch 260 and a second bit stream of the bit stream source 110 may be connected to the reconfigurable switch 360.

Optical WDM signals of the WDMS 120, 121, 123, 320, 321, 323 of the host A1 are optically communicated to WDMS 130, 131, 133, 330, 331, 333 of host B1 through optical fibers 351, 352, 353, 354, 355, 356. Received bit streams of the WDMS 130, 131, 133, 330, 331, 333 are connected to the reconfigurable switches 261, 361 of host B1.

Further, as shown, any output of each of reconfigurable switches 261, 361 can be electrically connected to any of inputs of bit stream sinks 140, 143, 340, 343. The reconfigurable switches 261, 361 then selectively connect each of the outputs of the reconfigurable switches 261, 361 to an input of bit stream sinks 140, 143, 340, 343. As shown, different bit streams of each of different reconfigurable switches 261, 361 can be connected to the bit stream sinks 140, 143, 340, 343. For example, a first bit stream of the reconfigurable switch 261 may be connected to the bit stream sink 140, a second bit stream of the reconfigurable switch 261 may be connected to the bit stream sink 143, a third bit stream of the reconfigurable switch 261 may be connected to the bit stream sink 340, and a fourth bit stream of the reconfigurable switch 261 may be connected to the bit stream sink 343,

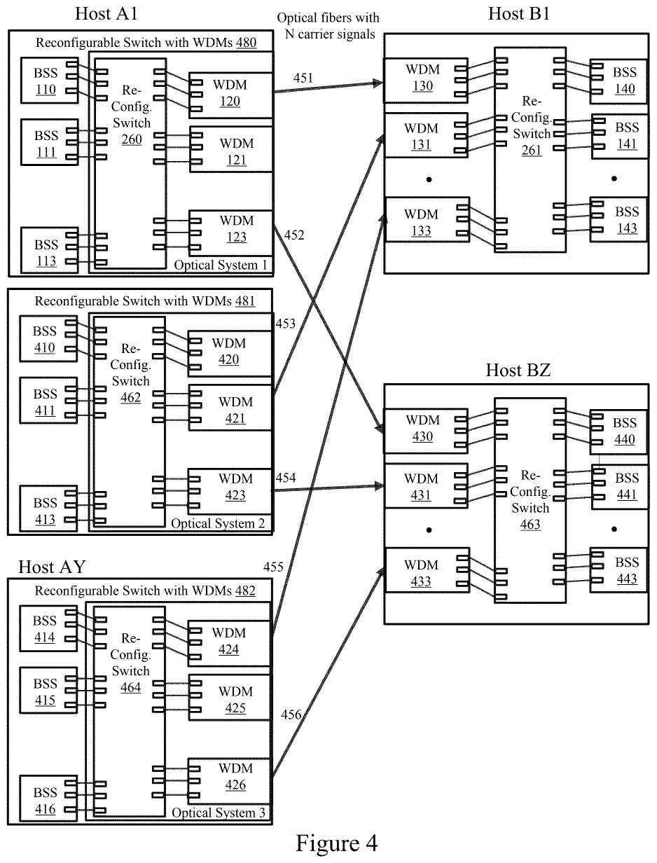

FIG. 4 shows an optical transceiver system, according to another embodiment. This embodiment includes several more hosts A1-AY, B1-BZ. Optical fibers 451, 452, 453, 454, 455, 456 provide optical communication links between WDMs 120, 121, 123, 420, 421, 423, 424, 425, 426 of the hosts A1-AY and WDMs 130, 131, 133, 430, 431, 433 of hosts B1-BZ. As shown, the reconfigurable switches 260, 462, 464, 261, 463 allow for the connection of any of the bit streams of any of the bit sources 110, 111, 113, 410, 411, 413, 414, 415, 416 through any of optical fibers 451, 452, 453, 454, 455, 456. This embodiment shows set optical fiber connections 451, 452, 453, 455, 456, wherein any of the bit streams can be selectively communicated across any of the set optical fiber connections 451, 452, 453, 455, 456 based on the selective connections of the reconfigurable switches 261, 463.

Further, the received bit streams of the WDMs 130, 131, 133, 430, 431, 433 may be selectively connected to the bit stream sinks 140, 141, 143, 440, 441, 443, based on the selective connections of the reconfigurable switches 260, 462, 464.

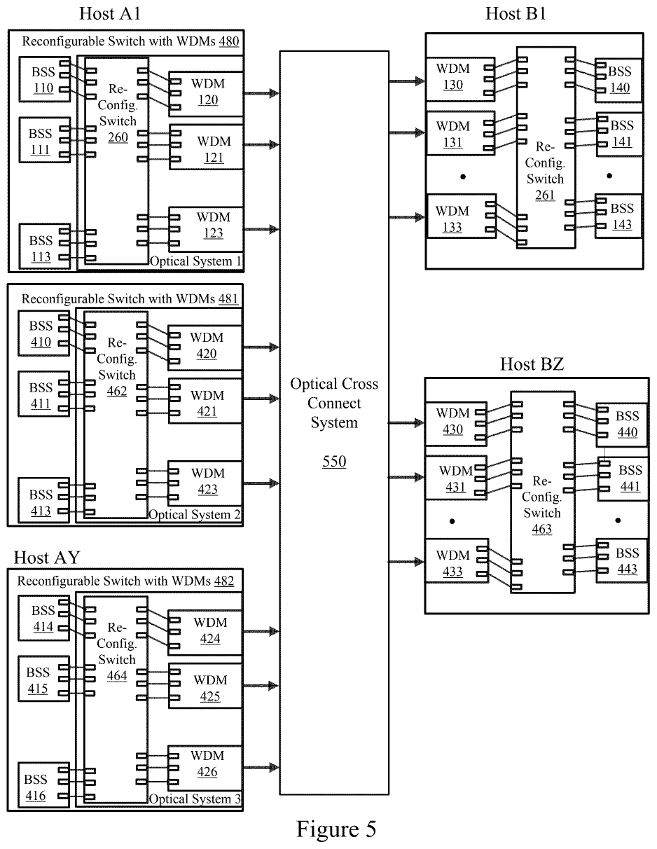

FIG. 5 shows an optical transmitter system that includes an optical cross connect system 550, according to another embodiment. For an embodiment, the optical cross connect system 550 is a reconfigurable optical switching fabric that can dynamically switch the optical signals from an input fiber to an output fiber (M×M optical fiber switch)—allowing the reconfiguration of the fiber connectivity in the date center. For an embodiment, the optical cross connect system 550 switches the entire contents of an input fiber to and output fiber. However, the optical cross connect system 550 cannot switch individual optical carriers within the optical fibers. For an embodiment, the optical cross connect system 550 can dynamically reconfigure the fiber connectivity (fiber infrastructure) in the data center (which its own controller). The reconfigurable switches are able to dynamically reconfigure which data streams are on which optical carrier and on which fiber (with its own controller). Combining these two (the optical cross connect system 550 and the reconfigurable switches 260, 462, 464) provides for an overall control that dynamically controls how the data center is wired from the data stream source 110, 111, 113, 410, 411, 413, 414, 415, 416 to optical fibers.

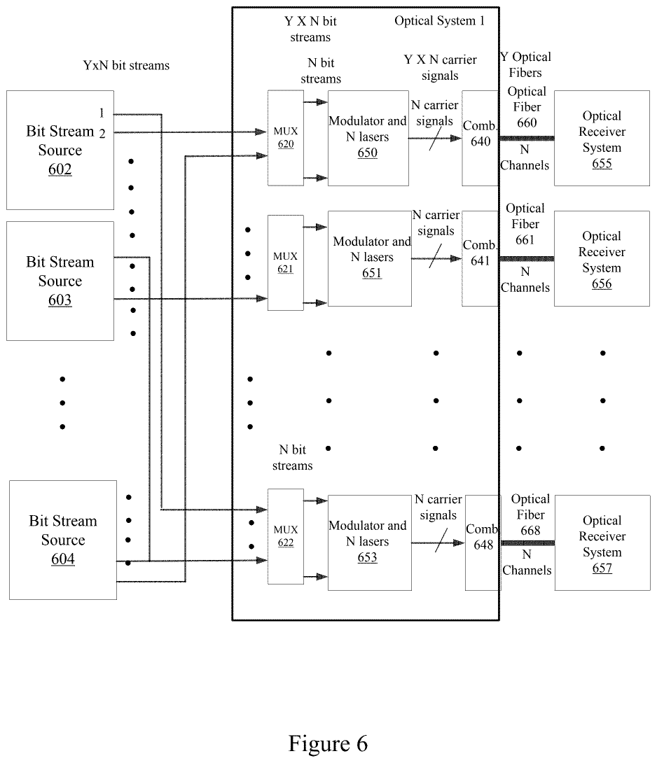

FIG. 6 shows an optical transmitter system, according to an embodiment. As shown, a plurality of bit stream sources 602, 603, 604 provide streams of bits that are to be communicated over a plurality of optical fibers 660, 661, 668. The data streams are provided to a plurality of WDMs 650, 651, 653. Each of the WDMs includes a set of N lasers that generate optical signals. The optical signal of each of the lasers is modulated with a selected bit stream of the provided streams of bits. The N modulated optical signals of each of the WDMs 650, 651, 653 are transmitted across a corresponding optical fiber 660, 661, 662 for reception by a corresponding optical receiver system 655, 656, 657. A set of combiners 640, 641, 648 are depicted to illustrate that the different carrier signals of each of the optical signals of each of the set of N lasers of each of the WDMs 650, 651, 653 are combined before being transmitted over the corresponding one of the optical fibers 660, 661, 662.

The bit stream sources 602, 603, 604 may include a GPUs (graphics processing units), a TPU (tensor processing units), and/or Ethernet switch ASIC (application specific integrated circuits). It is to be understood that this list is not to be limited to only the listed electronic devices. For an embodiment, each of the bit streams sources is a separate integrated circuit.

FIG. 6 illustrates that for an embodiment, any one of the bit streams of the bit sources 602, 603, 604 may be selectively (either beforehand, or as will be described, adaptively changed over time) connected to any one of the lasers of any one of the WDMs 650, 651, 653. Accordingly, any one of the bit streams of the bit sources 602, 603, 604 may be selectively communicated over any one of the carrier signals of any one of the optical fibers 660, 661, 662 to any one of the optical receiver systems 655, 656, 657.

For an embodiment, the selections of which of the bit streams of the bit sources 602, 603, 604 is selectively communicated over any one of the carrier signals of any one of the optical fibers 660, 661, 662 to any one of the optical receiver system 655, 656, 657 is predetermined and hardwired through, for example, conductive traces between the bit sources 602, 603, 604 and the inputs to the WDMs 650, 651, 653. Accordingly, any one of the outputs of the bit sources 602, 603, 604 may be selectively communicated across any one of selectable wavelengths of an optical signal of any one of the optical fibers 660, 661, 668.

FIG. 6 includes MUXs 620, 621, 622 which receive the bit streams of the bit sources 602, 603, 604 that are selectively connected to the plurality of WDMs 650, 651, 653. Each WDM needs to have the N bit streams for communication over each of the N carrier signals of the WDM. For an embodiment, each multiplexer 620, 621, 622 is configured to receive input data streams and generate N laser data streams. The input data streams of the bit stream sources 602, 603, 604 can be of varied data rates, and the MUXs 620, 621, 622 ensure that the bit streams provided to the WDMs 650, 651, 653 are of the same data rate.

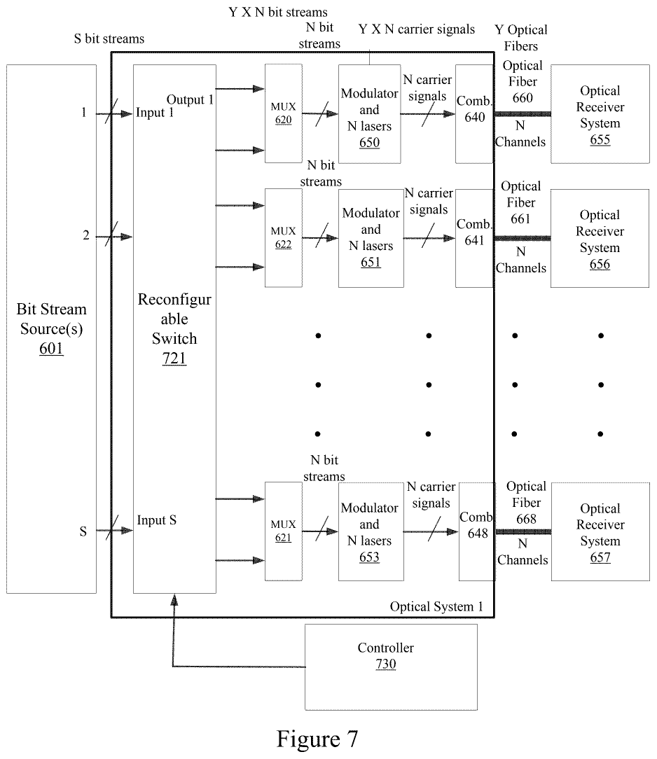

FIG. 7 shows an optical transmitter system, according to another embodiment. As shown, for this embodiment, a reconfigurable switch 721 allows for selection of which bit streams of S bit streams provided by one or more bit stream sources 601 is communicated over which carrier frequency or wavelength of which optical fiber 660, 661, 662 to which optical receiver system 655, 656, 657. As shown, for an embodiment, each of the WDMs 650, 651, 652 receives N bit streams from the reconfigurable switch 721. Further, as shown, the reconfigurable switch 721 receives the S bit streams and selectively connects any one of the S bit streams to any one of the WDMs 650, 651, 652 for communication over the optical fibers 660, 661, 668 over any one of the carrier frequencies of the optical signals communicated over each of the optical fibers 660, 661, 668. It is to be noted that the selection can change over time, and therefore, can adaptively avoid particular optical fibers 660, 661, 668, avoid particular lasers of the WDMs 650, 651, 652, or avoid particular WDMs 650, 651, 652.

For an embodiment, the reconfigurable switch configured to receive the plurality input bit streams, wherein the plurality input bit streams includes up to Y×N bit streams and connect each of the up to Y×N of the plurality of input streams to Y×N outputs of the reconfigurable switch, wherein each of the Y×N outputs of the reconfigurable switch are connected to a corresponding one of the modulators of the Y WDMs 650, 651, 653.

For an embodiment, a controller 730 controls the selections of the reconfigurable switch 721. For an embodiment, the controller is configured to select switch connections of the reconfigurable switch to enable selection of which of the plurality input bit streams is communicated over which of the Y optical fibers 660, 661, 668. For an embodiment, the selections vary over time.

Various embodiments utilize information about the optical network to control the selections of the reconfigurable switch 721. For example, the optical network may sense or determine that one or more of the optical fibers are not working properly or not working at all. The controller 730 can use this information to selectively avoid specific optical fibers. Further, as will be described, one or more of the WDMs 650, 651, 653 may include redundant laser and the controller (or another separate controller) may select N of M available laser based on the information of which of the optical fibers are not properly working. As previously described, the switch selections of the reconfigurable switch can be used to avoid specific lasers.

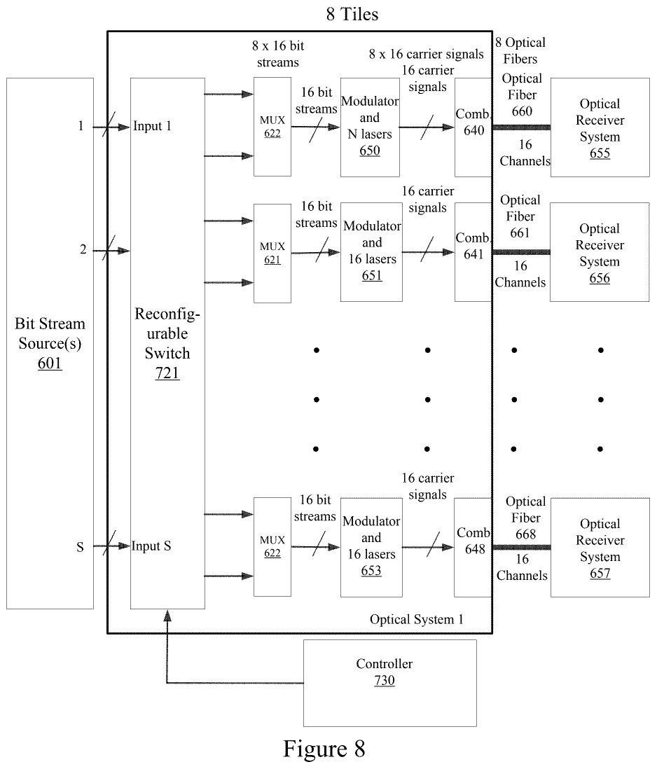

FIG. 8 shows an optical transmitter system, according to another embodiment. FIG. 8 illustrates a specific example of the number of bit streams and the number of optical fibers. As shown, an embodiment includes 8 optical fibers (Y=8) each carry 16 bit streams (N=16). Accordingly, 128 bit streams are communicated across 8 optical fibers 660, 661, 668.

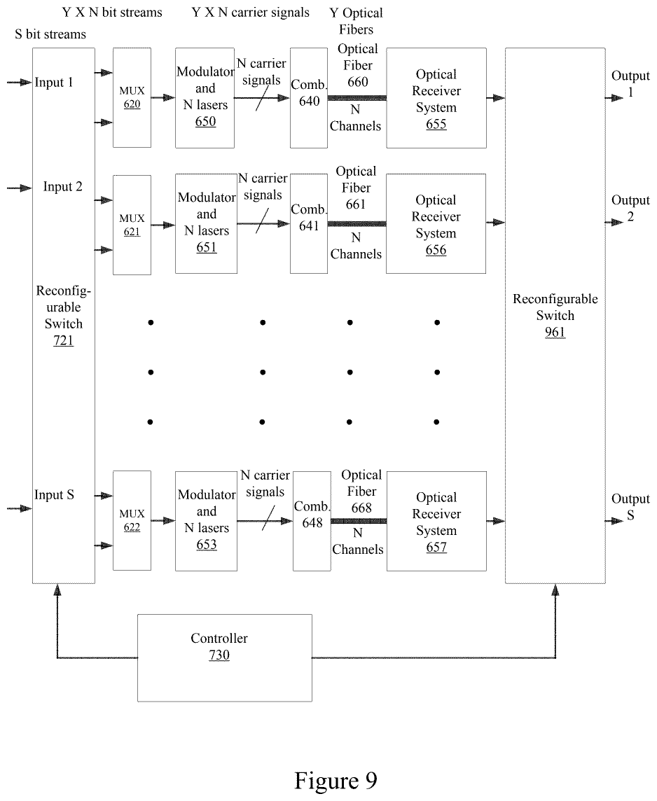

FIG. 9 shows an optical transmitter system that includes both first and second reconfigurable switches 621, 961, according to another embodiment. As shown, for an embodiment, the optical system includes an optical reception system that includes Y optical receiver systems 655, 656, 657. For an embodiment, each of the Y optical receiver system is configured to receive and demodulate a corresponding one of the Y optical communication signals resulting in Y groups of N received bit streams. For an embodiment, the second reconfigurable switch 961 is configured to receive Y×N bit streams and connect each of the Y×N received bit streams to outputs (S) of the second reconfigurable switch, wherein S may include up to Y×N bit streams.

As described, for an embodiment, the configurable switch 621 and the second reconfigurable switch 961 are configured to selectively connect any input to any output. For an embodiment, the configurable switch 621 is configured to connect any one of S input data streams to Y×N outputs of the configurable switch 621, wherein S>=Y×N. Each of the WDMs 650, 651, 653 receive N bit streams of the Y×N bit streams of the Y×N outputs of the configurable switch 621. For an embodiment, the second configurable switch 961 is configured to connect any one of Y×N input data streams to S outputs of the second configurable switch 961, wherein S>=Y×N. Each of the WDMs 650, 651, 653 provide N bit streams of the Y×N bit streams of the Y×N inputs of the second configurable switch 961.

For an embodiment, the plurality input bit streams received by the reconfigurable switch 621 matched the received bit streams at the up to Y×N outputs of the second reconfigurable switch 961. That is, for an embodiment, the bit streams input to the optical system essentially match the bits streams output from the optical system. Further, the controller 630 is configured to selectively select the settings of switch selections of the reconfigurable switch 621 and the second reconfigurable switch 961 to selectively determine which optical fiber 660, 661, 668 each of the bit streams propagate through from the reconfigurable switch 621 to the second reconfigurable switch 961. Accordingly, the combination of the controller 630, the reconfigurable switch 621, and the second reconfigurable switch 961 provide a very high level of control of the utilization of the optical fibers 660, 661, 668, and selection of lasers within the WDMs 650, 651, 653 as will be described.

For an embodiment, the controller 630 is further configured to control the reconfigurable switch 621 and the second reconfigurable switch 961 to connect the input bit streams over optical fibers that are operational, thereby avoiding non-operational optical fibers. That is, if one of the optical fibers 660, 661, 668 within, for example, a data center fails or becomes inoperable, the controller has the capability to select interconnections between the reconfigurable switch 621 and the second reconfigurable switch 961 to avoid such optical fibers. The failure sensing and reselection can be automatically performed by the controller 630, or by another controller that communicates such reselections to the controller 630, or by a combination of the controller 630 and the other controller. That is, for an embodiment, the controller 630 is configured to determine non-operational optical fibers, and control the reconfigurable switch 621 and the second reconfigurable switch 961 to connect the input bit streams over optical fibers that are operational, thereby avoiding the non-operational optical fibers.

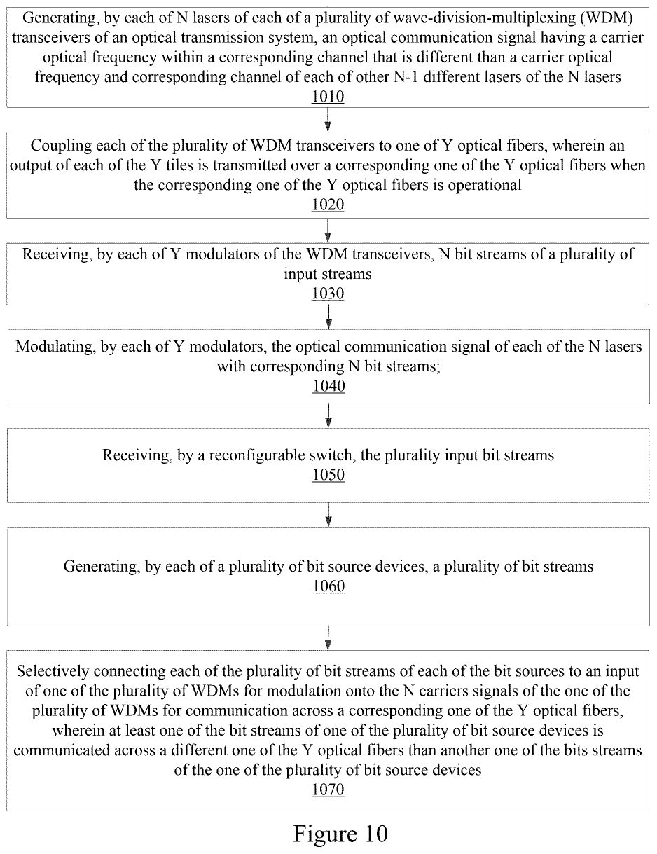

FIG. 10 is a flow chart that includes steps of a method of mapping bit streams across each of a plurality of optical fibers, according to an embodiment. A first step 1010 includes generating, by each of N lasers of each of a plurality of wave-division-multiplexing (WDM) transceivers of an optical transmission system, an optical communication signal having a carrier optical frequency within a corresponding channel that is different than a carrier optical frequency and corresponding channel of each of other N-1 different lasers of the N lasers. A second step 1020 includes coupling each of the plurality of WDM transceivers to one of Y optical fibers, wherein an output of each of the Y WDMs is transmitted over a corresponding one of the Y optical fibers when the corresponding one of the Y optical fibers is operational. A third step 1030 includes receiving, by each of modulators of the WDM transceivers, N bit streams of a plurality of input streams. A fourth step 1040 includes modulating, by each of modulators, the optical communication signal of each of the N lasers with corresponding N bit streams. A fifth step 1050 includes receiving, by a reconfigurable switch, the plurality input bit streams. A sixth step 1060 includes generating, by each of a plurality of bit source devices, a plurality of bit streams. A seventh step 1070 includes selectively connecting each of the plurality of bit streams of each of the bit sources to an input of one of the plurality of WDMs for modulation onto the N carriers signals of the one of the plurality of WDMs for communication across a corresponding one of the Y optical fibers, wherein at least one of the bit streams of one of the plurality of bit source devices is communicated across a different one of the Y optical fibers than another one of the bits streams of the one of the plurality of bit source devices.

While the embodiments described are directed to Y WDMs, an alternate embodiment includes Y spatial division multiplexers (SDMs). That is, SDMs may alternatively be used instead of WDMs. For an embodiment, N=1, and each of the SDMs provides a modulated carrier signal that is coupled or connected to a spatially different location of an multicore optical fiber. That is, each of the Y fibers are one spatially separate core of a multi-core optical fiber, the multi-core optical fiber connected between a first optical transceiver system and a second optical transceiver system. More generally, the Y fibers are an optical transmission medium adapted to receive a plurality of Y spatially separate optical signals, the optical transmission medium connected between a first optical transceiver system and a second optical transceiver system.

For an embodiment, one or more of the previously described WDMs of the optical communication system includes M different selectable lasers, each of the M different lasers configured to generate an optical communication signal having a carrier optical frequency within a corresponding channel that is different that a carrier That is, the carrier optical frequency of each of the M different lasers in within a different channel. The optical transmitter system further includes a controller (which may be the previously described controller 730) that is configured to select and map N of the M selectable lasers based on feedback of a quality of one or more of the M lasers, wherein N<M. For an embodiment, the N lasers each generate an optical carrier signal having a signal quality better than a predetermined threshold. For an embodiment, the N lasers each generate an optical carrier signal having a signal quality that is one of the N best. The optical transmitter system further includes a switch selector configured to select the N of the M selectable laser for transmission over an optical fiber to a second optical receiver system. For an embodiment, a mapping of the input data streams to the N laser data streams is modulated on each of the carrier signals of the selected N lasers. For an embodiment, data speeds on the different channels of the different carrier optical frequencies can be or are different.

A specific implementation of the optical transmitter system includes 16 (N) lasers fully operational until the end of life of the optical communication system. For example, the optical transmitter system may be required to be operational for 5 years in a data center with a probability of 99.999%. Performing a reliability analysis assuming an operating environment may indicate that 2 lasers will fail with a certain probability. To ensure operation of the 16 lasers, the results of the analysis suggest that operation be started with 18 (M) lasers, with the assumption that 2 of the lasers will fail over the useful lifetime of the system.

For an embodiment, burn-in of the lasers can additionally be accounted for in the redundancy. If the yield loss after burn-in is <=10%, the number M of lasers may be selected to be 20, thereby accounting for burn-in failure and end of life failure. Increasing the number of M lasers to 22 may yield a 50% chance that there will be 20 operational lasers out of 22, thereby accounting for increasing wafer production yield.

At least some embodiments include increasing the value of M further to accommodate for manufacturing yield, elimination of burn-in etc.

An exemplary 1000 Gbps optical transmitter system includes 16 operational lasers, with each laser having a payload data rate of 50 Gbps, and a coding overhead of 6 Gbps. Therefore, each laser must carry 56 Gbps. In order to realize 16 operational lasers in operation at the end of a 5-year useful life, factors including reliability calculations, environment of operation, data from accelerated testing, etc. Computing based on these factors suggests that 18 lasers are needed to guarantee 16 operational lasers. Further, burn-in tests indicate a loss of 1 laser out of 19 for a 5-year burn-in, suggesting 19 lasers are needed to be packaged. Further, it can be determined that production of just 19 lasers in the array results in a manufacturing yield that is extremely small (<10%). Empirical data and defect analysis suggests that 3 more lasers need to be added to increase the manufacturing yield to 50%. This all suggests that 22 lasers in the array are needed to provide a 50% manufacturing yield, elimination of the burn-in process, and to ensure 16 laser operating laser at the end of life.

For an embodiment, the optical transmitter system is formed on an integrated circuit. For an embodiment, the integrated circuit may support a total bandwidth for the optical transmitter system of 4.4 THz. If the carrier optical frequency each of the lasers of the optical transmitter system is spaced 200 GHz from the other lasers, then a total of only 22 different lasers may be formed, thereby limiting the number M of possible lasers in which the N lasers are selected. As previously described, for an embodiment, data speeds on the different channels of the different carrier optical frequencies can be or are different.

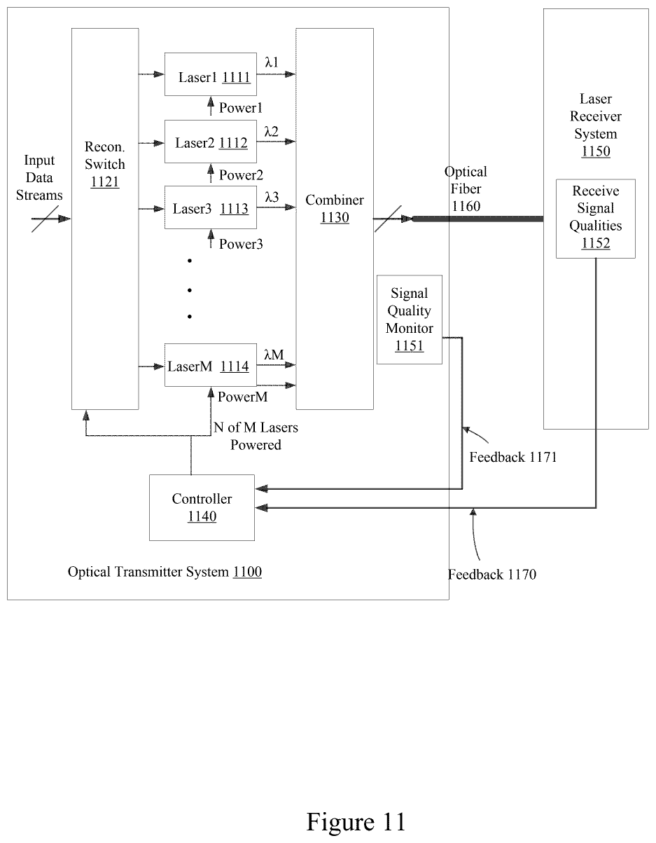

FIG. 11 shows an optical communication system, according to an embodiment. As shown, an optical transmitter system 1100 includes M different selectable lasers 1111, 1112, 1113, 1114, wherein each of the M different lasers 1111, 1112, 1113, 1114 is configured to generate an optical communication signal having a carrier optical frequency within a corresponding channel that is different that a carrier optical frequency and corresponding channel of each of the other M-1 different lasers of the M lasers. As previously described, the M different selectable lasers are utilized to ensure through redundancy that at least N of the required number of lasers are operational over the lifetime of the optical communication system. The channels corresponding with each of the carrier optical frequencies of each of the M laser have designated center frequencies and frequency passbands, wherein the passbands of each of the channels are substantially non-overlapping in frequency.

For an embodiment, a controller 1140 is configured to select and map N of the M selectable lasers, wherein N<M. As will be described, the N lasers are selected to ensure a level of performance of N optical carrier signals propagating across an optical fiber 1160 to a second optical receiver system 1150. Further, as described, the redundancy accounts for possible failure of one or more of the M lasers. Further, the performance of the M lasers can be monitored over time, and the N laser can be selected to ensure a preselected level of performance of the N optical carrier signals being communicated across the optical fiber 1160 to the second optical receiver system 1150. For an embodiment, the selection of the N of the M selectable lasers is based on feedback regarding a quality of one or more of the M different lasers.

For an embodiment, a switch selector is configured to select the N of the M selectable lasers for transmission over the optical fiber 1160 to the second optical receiver system 1150. For an embodiment, the N laser selected are active (powered), and the other M-N lasers are off (not powered). For an embodiment, all M lasers are active (powered) and the N lasers are selected to carry data streams.

For an embodiment, a reconfigurable switch 1121 is configured to receive input data streams. For an embodiment, K input data streams are provided to the WDM, wherein the K input data streams can be of varied data rates. For example, any one of the K input data streams may be 200 Gbps or 100 Gbps while each of the N laser data streams may be 50 Gbps. Any of the K input data streams may be 50 Gbps or 25 Gbps, while each of the N laser data streams may be 50 Gbps. For an embodiment, the K input data streams are mapped to N laser data streams. The N selection is determined from the M lasers, and then the mapping of the K input data streams can be determined from the selected N lasers. For an embodiment, the second optical receiver system 1150 needs to know the mapping of the K input data streams to the N laser data streams so that the second optical receiver system can reconstruct the K input data streams after transmission through the optical fiber 1160. Accordingly, for an embodiment the mapping of the K input data steams to the N selected lasers is communicated to the second optical receiver system 1150.

For an embodiment, the mapping of the N of the M selectable lasers is modulated on each of the carrier signals of the selected N lasers. For an embodiment, the mapping of the K input data steams to the N selected lasers is modulated on each of the carrier signals of the selected N lasers. For an embodiment, the second optical receiver system 1150 needs to know which of the M lasers are selected so that the second optical receiver system 1150 knows the frequency or wavelength in which the N carrier signals and channels of the N lasers are located. Accordingly, for an embodiment, all N of the carrier signals carry the mapping of the N of the M selectable lasers. For an embodiment, the mapping is included with all M carrier signals of which N are selected for transmission across the optical fiber 1160. For an embodiment the mapping is included over at least a time interval, wherein the second optical receiving system knows when the time interval occurs.

As described, the M lasers are available for selecting the N laser to provide redundancy. That is, the laser can have a limited projected end of life. Accordingly, additional lasers can be included and selected from to ensure that at least a minimum number N of the laser are available for use. For an embodiment, the number M is selected based on knowledge and estimates of the projected end of life of the M different selectable lasers. It is to be understood that the number of M different selectable lasers can additionally be selected based on a burn-in rate of the lasers, and/or a manufacturing yield of the lasers. For an embodiment, the redundancy of the transmission system allows for elimination of “Infant mortality testing” of the lasers, sudden failures of the lasers in field, and long-term gradual wear-out of the lasers in field.

As previously described, the N selected lasers are selected based on a signal quality of each of the transmission signals of each of the M lasers. For an embodiment, the N selected lasers are selected from the M lasers based on a transmit power of N modulated carrier signals. For an embodiment, the N selected lasers are selected from the M lasers based on a signal quality or characteristic of the N modulated carrier signals. For an embodiment, the N selected lasers are selected from the M lasers based on an estimated BER (bit error rate) of N modulated carrier signals. For an embodiment, the N selected lasers are selected from the M lasers based on wavelength of N modulated carrier signals. For an embodiment, the N selected lasers are selected from the M lasers based on Side Mode Suppression Ratio (SMSR) of N modulated carrier signals.

As shown, for an embodiment, the controller 1140 receives feedback 1171 from a signal quality detector 1151 within the optical transmitter system 1100. For an embodiment, the signal quality detector is as simple as a power detector of each of the N carrier signals. However, the signal quality detector can additionally or alternatively include other types of signal quality detectors. Further, as shown in FIG. 11, for an embodiment, feedback 1170 from the second optical receiver system 1150 includes receive signal quality monitor 1152 of the N carrier signals received by the second optical receiver system 1150. For an embodiment, two-way communication is supported by having optical transmitter systems and optical receiver systems on both sides of the optical fiber 1160.

For an embodiment, the controller 1140 is further configured to receive feedback from the second optical receiver system of the N modulated lasers, and adaptively update the mapping of the N of the M selectable lasers based on the received feedback. For an embodiment, the feedback includes measured values of the signal qualities of each of the N modulated carrier signals. The feedback 1170 provides real time or near real time feedback on the performance of the modulated carriers of the N selected lasers. For an embodiment, upon startup, the selection provides a set of N selected lasers that meet a threshold level of communication quality. For an embodiment, upon startup, the selection provides a set of N selected lasers that provide the best level of communication quality. During operation, continual selection provides adaptive updating that meets the threshold level of communication quality, or the best level of communication quality.

For an embodiment, the controller 1140 is further configured to track a history of the mapping over time, document the failed lasers, and adaptively influence the selection of the N selected laser based on the history of the mapping. For example, tracking the performance over time can provide an indication of a particular one or more of the N selected laser in which the performance is degrading over time. Such degradation can be used to trigger a reselection of the N select lasers. Alternatively, the degradation may provide an indication that one or more lasers will fail, and therefore, trigger checking the selection of the N laser more frequently. For an embodiment, the indication that one or more of the lasers will fail triggers a reselection of the N laser that does not include the failing or previously failed laser.

For an embodiment, the controller 1140 is further configured to code selected and non-selected lasers with the same code and track a signal quality of both the selected and non-selected lasers. For example, during a testing or calibration period or periods, the N selected lasers may be varied in order that unselected lasers may be tested as well. Using the same coding on all the carrier signals allows for even or fair testing and selection of the N lasers. Further, an order or sequence of the selected N carrier signal may be tested for optimally testing signal quality and inter channel interference (ICI). An embodiment includes periodically (or triggered) testing of the non-selected laser over time. Therefore, the selected N lasers can be adapted over time.

For an embodiment, the controller 1140 is further configured to receive feedback from the second optical receiver system 1150 of the N modulated lasers, and adaptively adjust a coding of data streams of the modulated carriers. For an embodiment, the feedback includes a received signal quality which is tracked over time, and wherein the coding is increased for select of the N modulated carrier signals as the received signal quality of one or more of the N modulated carrier signals degrades over time. For an embodiment, a threshold level of communication quality may be required of each of the carrier signals to ensure a threshold level of performance of the communication of the N carrier signals across the optical fiber 1160. Accordingly, an embodiment includes increasing coding of one or more of the N carrier signals to ensure that all of the N carrier signals meet the threshold level of communication quality.

For an embodiment, the controller 1140 is further configured to receive feedback from a receiver of the N modulated lasers, and adaptively adjust an amplitude (power level) of the modulated carriers. For an embodiment, the feedback includes a received signal quality which is tracked over time, and a bias current is increased for select of the N selected lasers as the received signal quality of one or more of the N modulated carrier signals degrades over time.

For an embodiment, MAC (media access control) packets included as information within the modulated carrier signals of the N selected lasers include the mapping of the selection of the N of the M selectable lasers, thereby conveying the mapping to an optical receiver of the modulated carrier signals. For an embodiment, MAC (media access control) packets included as information within the modulated carrier signals of the N selected lasers include the mapping of the selection of the K bit steams to the N laser data streams, thereby conveying the mapping to an optical receiver of the modulated carrier signals.

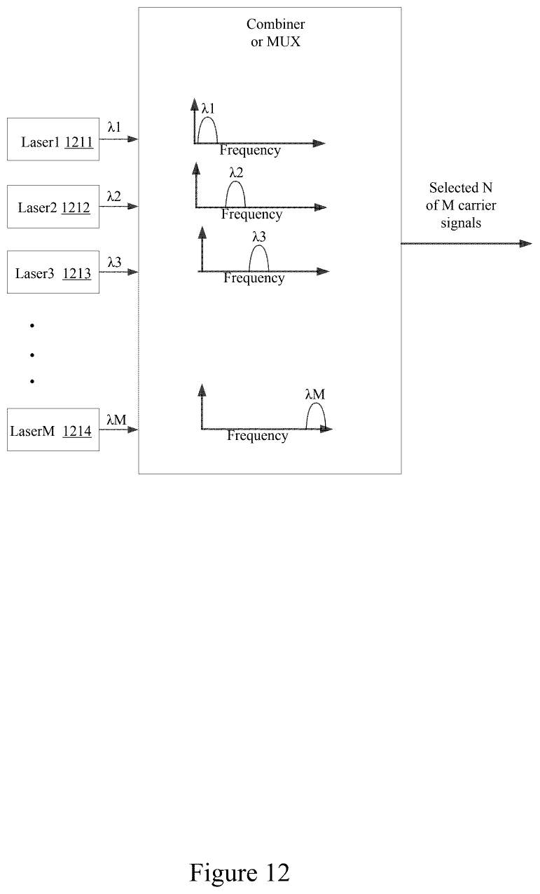

FIG. 12 shows passband filtering of each carrier signal of an optical communication system, according to an embodiment. As shown, the output of each of the lasers 1211, 1212, 1213, 1214 can be filtered by a bandpass filter (of a combiner or MUX) that is ideally centered at the wavelength of the corresponding carrier signal of the laser. The filtering reduces inter-channel interference (ICI) between carrier optical signals. For an embodiment, M different bandpass filters provide filtering of all M carrier optical signals of the M lasers. When only N of the M laser is active, the filtering occurs for the N carrier signals of the N lasers. However, the M bandpass filters are still present because the selected N of the M lasers can change at any time. For an embodiment, the bandpass filters are frequency-aligned with the corresponding channel of each of the carrier optical frequencies of the M lasers.

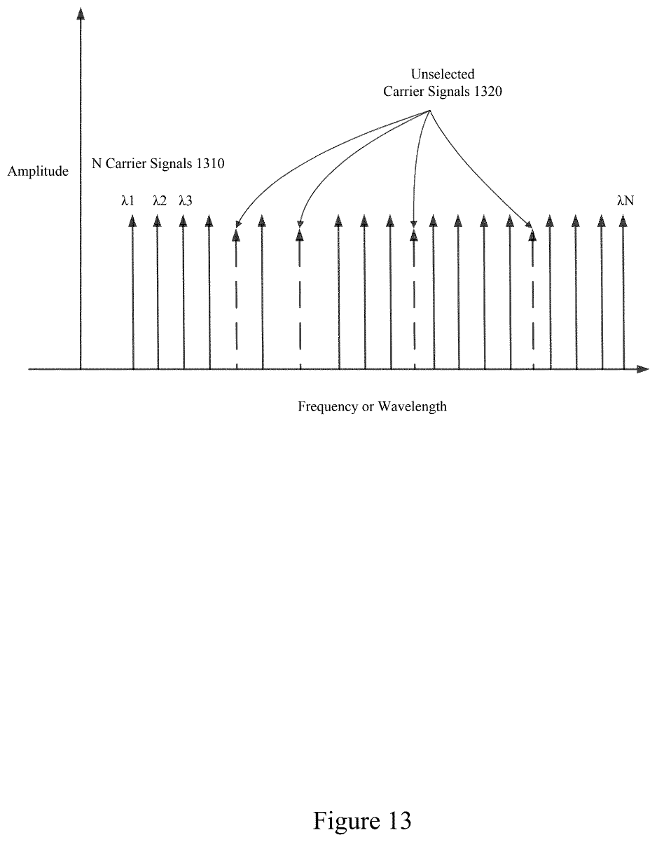

FIG. 13 is a frequency spectrum of carrier signals of the optical communication system, according to an embodiment. For an embodiment, the carrier signals are spaced 200 GHz apart from each other. As shown, the frequency spectrum may include the selected N carrier signals 1310, and unselected carrier signals 1320 of the M lasers. As previously described, the selection of the N lasers of the N carrier signals can be based on various communication quality parameters. For an embodiment, the N lasers are selected to provide the best level of communication quality. For an embodiment, the N lasers are selected to provide at least a threshold level of communication quality.

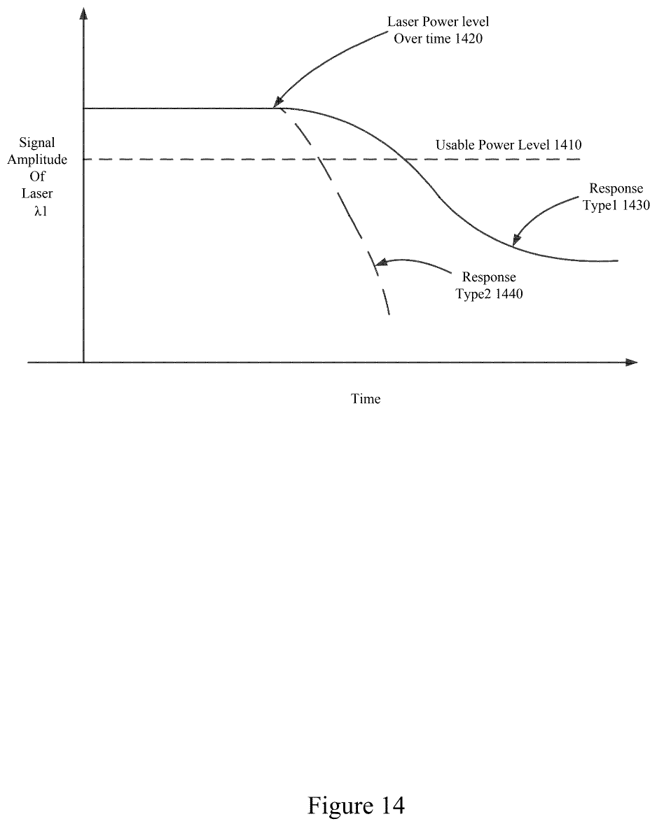

FIG. 14 shows power curves of a laser, according to an embodiment. As shown, the power level output of one or more of the M lasers may degrade over time. The units of time for the power curve (laser power level over time 1420) of FIG. 14 may be small (fractional seconds) or very large (months or years). However, an expected life of the lasers can be estimated based on a rate of change of the power curve of the laser. Different power curves may exhibit different characteristics that can be used to identify specific or general potential problems with the laser. A first response type1 1430 may degrade slowly. A second response type2 1440 may degrade more quickly. The different degradation characteristics can be used to categorize and predict the life of the lasers. The sensed degradation of the lasers can be used to select how frequently to test the quality of each laser and reselect the N lasers. The sensed degradation of the lasers can be used to identify a laser to avoid selecting the degraded laser. As long as the output (signal amplitude) of the laser is above a usable power level 1410, the laser may be selected for use.

In general, the failure modes of the lasers can be characterized into 3 different types: 1) infant mortality which happens at the very early stage, and is usually screened by burn in, 2) sudden failure which results in significant power drop in a short time frame, but can happen at a random time along the whole lifetime span of the laser, 3) gradual wear out which show a degradation trend over time, wherein some lasers can reach the performance threshold earlier, some lasers later. If a signal carrier of a laser degrades below a selected quality threshold (useable power level 1410), then a laser selection or reselection needs to be made to switch to using a different set of N lasers to ensure a desired level of performance of the optical transmitter system. Besides an output power drop, there are also other scenarios of laser degradation, such as, stress-relaxation induced wavelength change and bandwidth (modulation speed) change.

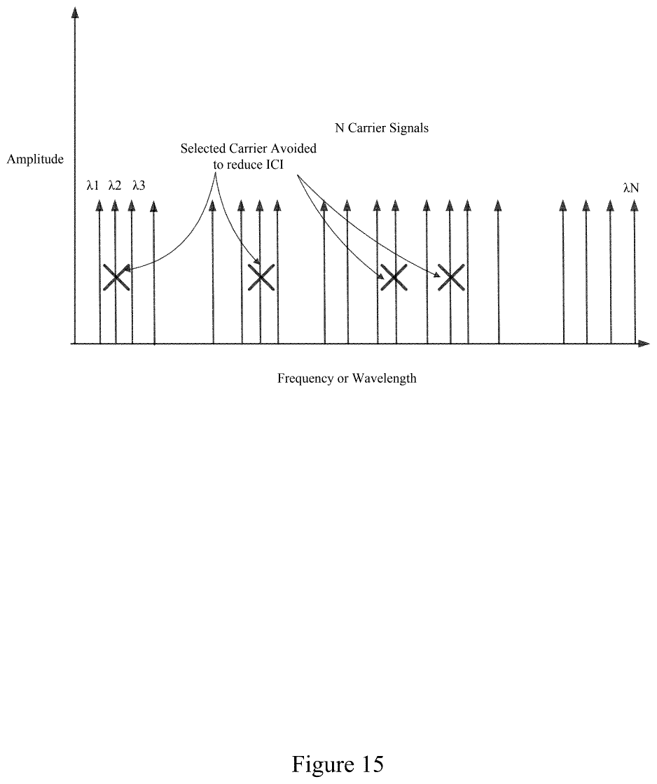

FIG. 15 shows a frequency spectrum of carrier signals of the optical transmitter system in which carrier signals are selected to reduce inter-channel interference, according to an embodiment. ICI can occur between different carrier signals of the N carrier signals. An embodiment includes mitigating ICI between carriers through the selection of the N carriers. That is, for example, if adjacent carrier signals suffer from a greater amount of ICI than desired, the carrier frequency locations can be adjusted through a reselection of the N lasers. For an embodiment, the N selected lasers are selected to maintain a selected frequency/wavelength spacing between each or one or more of the N carrier signals.

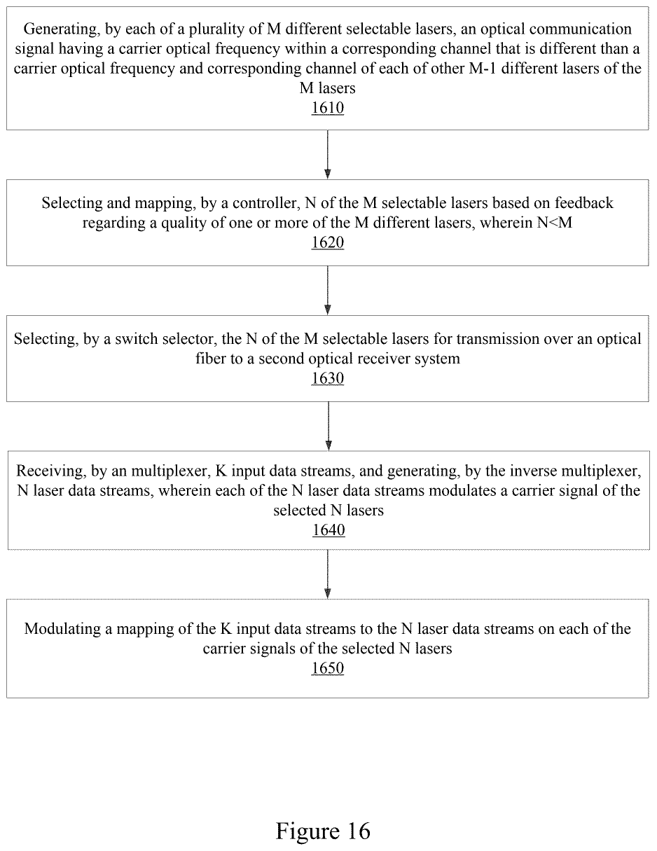

FIG. 16 is a flow chart that includes steps of a method of laser transmission, according to an embodiment. A first step 1610 includes generating, by each of a plurality of M different selectable lasers, an optical communication signal having a carrier optical frequency within a corresponding channel that is different than a carrier optical frequency and corresponding channel of each of other M-1 different lasers of the M lasers. A second step 1620 includes selecting and mapping, by a controller, N of the M selectable lasers based on feedback regarding a quality of one or more of the M different lasers, wherein N<M. A third step 1630 includes selecting, by a switch selector, the N of the M selectable lasers for transmission over an optical fiber to a second optical receiver system. A fourth step 1640 includes receiving, by a multiplexer (reconfigurable switch), K input data streams, and generating, by the multiplexer, N laser data streams, wherein each of the N laser data streams modulates a carrier signal of the selected N lasers. A fifth step 1650 includes modulating a mapping of the K input data streams to the N laser data streams on each of the carrier signals of the selected N lasers.

As described, each of the carrier optical frequencies corresponds with a different communication channel. For an embodiment, the passband of each of the communication channels are not overlapping over the useful range of frequencies within each of the passbands.

At least some embodiments further include reselecting and mapping a new N of the M selectable lasers based on the quality received via the feedback. That is, over time the quality of the selected lasers may vary, and a reselection of the N of the M possible laser is made based on the feedback of the quality of the selected N lasers.

As previously described, for an embodiment, the optical transmitter system receives K input data streams. For an embodiment, the K input data streams are mapped to the selected N lasers after the N of the M selectable laser are mapped. As previously described, the K input data streams can be of varied data rates. For example, any one of the K input data streams may be 200 Gbps or 100 Gbps while each of the N laser data streams may be 50 Gbps. Any of the K input data streams may be 50 Gbps or 25 Gbps, while each of the N laser data streams may be 50 Gbps. For an embodiment, the K input data streams are mapped to N laser data streams. The N selection is determined from the M lasers, and then the mapping of the K input data streams can be determined from the selected N lasers. For an embodiment, the second optical receiver system needs to know the mapping of the K input data streams to the N laser data streams so the that the second optical receiver system can reconstruct the K input data streams after transmission through the optical fiber. Accordingly, for an embodiment the mapping of the K input data steams to the N selected lasers is communicated to the second optical receiver system.

For an embodiment, the switch selector selectively activates the N of the M lasers, wherein the unselected lasers are not activated. That is, unselected lasers are not activated which saves power and can extend the life of the unselected lasers. For an embodiment, quality characterizations of the lasers performed at one time are assumed to be retained for an unselected laser at a later time.

For an embodiment, mapping of the N of the M selectable lasers is modulated on M lasers. For an embodiment, mapping of the K input data stream to the N laser data streams is modulated on M lasers. Accordingly, the second optical receiver system can determine the mappings.

As previously described, for an embodiment, M is selected based on at least a projected end of life of the M different selectable lasers. As previously described, each laser can have a limited projected end of life. Accordingly, additional lasers can be included and selected from to ensure that at least a minimum number N of the lasers are available for use. For an embodiment, the number M is selected based on knowledge and estimates of the projected end of life of the M different selectable lasers. It is to be understood that the number of M different selectable lasers can additionally be selected based on a burn-in rate of the lasers, and/or a manufacturing yield of the lasers. For an embodiment, the redundancy of the transmission system allows for elimination of “Infant mortality testing” of the lasers, sudden failures of the lasers in field, and long-term gradual wear-out of the lasers in field.

As previously described, for an embodiment, the N selected lasers are selected based on a signal quality of each of the transmission signals of each of the M lasers. The signal quality can be determined in several different ways. For an embodiment, the N selected lasers are selected from the M lasers based on an estimated BER (bit error rate) of N modulated carrier signals. For an embodiment, the N selected lasers are selected to maintain a selected frequency spacing between each of the N carrier signals.

For an embodiment, MAC packets included as information within the modulated carrier signals of the N selected lasers include the mapping of the selection of the N of the M selectable lasers, thereby conveying the mapping to an optical receiver of the modulated carrier signals. Alternatively, or additionally, the information within the MAC packets includes the mapping of the K input data streams to the N laser data streams of the N selected lasers.

An embodiment further includes receiving feedback from a receiver of the N modulated lasers, and adaptively updates the mapping of the N of the M selectable lasers based on the received feedback. For an embodiment, the feedback includes measured values of the signal qualities of each of the N modulated carrier signals. Alternatively, or additionally, feedback is generated internally to the optical transmitter system and feedback to the controller.

An embodiment further includes tracking a history of the mapping over time, and adaptively influence the selection of the N selected laser based on the history of the mapping. For example, tracking the performance over time can provide an indication of a particular one or more of the N selected laser in which the performance is degrading over time. Such degradation can be used to trigger a reselection of the N select lasers. Alternatively, the degradation may provide an indication that one or more lasers will fail, and therefore, trigger checking the selection of the N laser more frequently. For an embodiment, the indication that one or more of the lasers will fail triggers a reselection of the N laser that does not include the failing or previously failed laser.

An embodiment further includes coding selected and non-selected lasers with a same code and tracking a signal quality of both the selected and non-selected lasers. Non-selected lasers can be tracked by periodically or intermittently selecting the non-selected laser for characterization. However, an embodiment includes running an initial characterization of the M lasers. The initial characterization can be used to determine which lasers out of M are good-performing lasers, and the total number of good-performing (the best or better than a quality threshold) should be greater than N. For an embodiment, the N lasers are then selected, leaving several known good spare lasers (non-selected lasers). The other of the M non-selected lasers are power-off until they are to replace a failed laser. For an embodiment, it is assumed that the non-selected laser will not degrade during the time the lasers are power off, and therefore, the non-selected lasers do not need to be characterized at a later time. For an embodiment, when one or more of the N selected lasers needs to be replaced, then the entire M lasers can be recharacterized to ensure that the replacement laser is working as desired.

As previously described, an embodiment includes receiving feedback from a receiver of the N modulated lasers, and adaptively adjusts a coding of data streams of the modulated carriers. For an embodiment, the coding is across multiple carrier signals. For an embodiment, the coding is across carrier signals of the N selectable lasers. For an embodiment, the coding is across carrier signals of the M selectable lasers. As previously described, for an embodiment the feedback includes a received signal quality which is tracked over time, and wherein coding is increased for select of the N modulated carrier signals as the received signal quality of one or more of the N modulated carrier signals degrades over time.

As previously described, an embodiment includes receiving feedback from one or more sensors located within the optical transmitter system. As previously described, an embodiment includes receiving feedback from one or more sensors located within the second optical receiver system. Further, an embodiment includes receiving feedback from both the one or more sensors located within the optical transmitter system and from the one or more sensors located within the second optical receiver system. For an embodiment, the feedback includes signal quality (for example, power level) of the carrier signals of the optical lasers.

An embodiment includes adaptively adjusts an amplitude (power level) of the modulated carriers based on the feedback of the signal quality. For an embodiment, the feedback includes a received signal quality which is tracked over time, and wherein a bias current is increased for select of the N modulated carrier signals as the received signal quality of one or more of the N modulated carrier signals degrades over time.

As previously described, for an embodiment, a second optical transmitter system associated with the second optical receiver system configured to generate a second set of carrier signals for transmission over the optical fiber to an optical receiver system associated with the optical transmitter system. For an embodiment, the carrier frequencies (wavelengths) of the second set a carrier signals are selected to result in a frequency guard band between the second set of carrier signals and the carrier frequencies (wavelengths) of the M different lasers, wherein the guard band is selected to reduce ICI between the optical transmitter system and the second optical transmitter system.

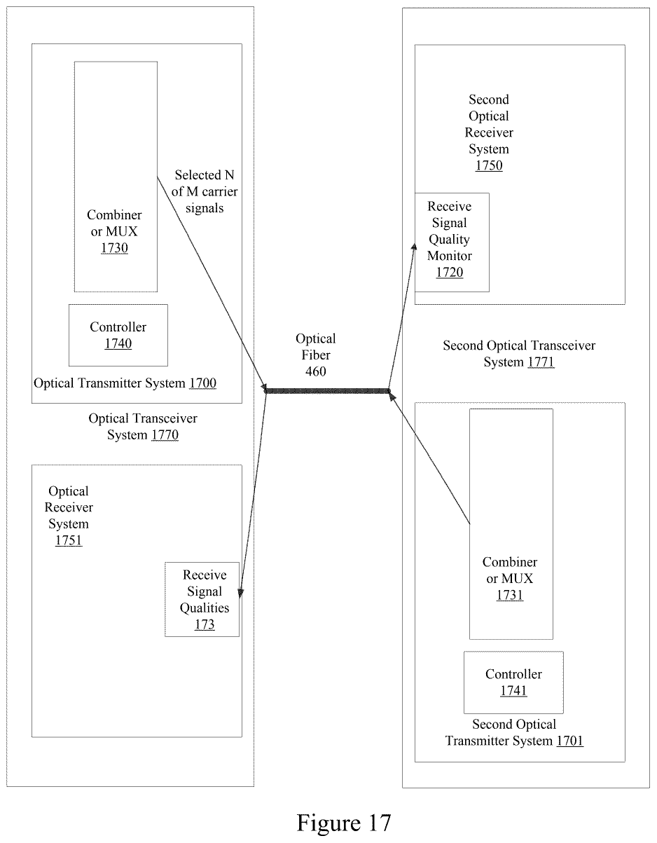

FIG. 17 shows a pair of laser transceivers, according to an embodiment. As shown, a first laser transceiver system 1770 includes an optical transmitter system 1700 and an optical receiver system 1751. A second laser transceiver system 1771 includes a second optical transmitter system 1701 and a second optical receiver system 1750. For an embodiment, both of the optical transmitter systems 1700, 1701 include the described embodiments for selecting N of M laser. As described, the optical transmitter system 1700 includes a controller 1740 and a combiner or MUX 1730. Further, the second optical receiver system 1750 includes receive signal quality monitor 1720. Similarly, the second optical transmitter system 1701 includes a controller 1741 and a combiner or MUX 1731. Further, the optical receiver system 1751 includes receive signal quality monitor 1730. The optical signals of the optical lasers of the optical transmitter system 1700 and the second optical transmitter system 1701 propagate across the optical fiber 460 to the second optical receiver system 1750 and the optical receiver system 1751.

Although specific embodiments have been described and illustrated, the embodiments are not to be limited to the specific forms or arrangements of parts so described and illustrated. The embodiments described are to only be limited by the claims.

What is claimed:

1. An optical system, comprising:
an optical transmission system, the optical transmission system comprising:
a plurality of wave-division-multiplexing (WDM) transceivers, each of the WDM transceivers comprising a plurality N lasers, each of the N lasers configured to generate an optical communication signal having a carrier optical frequency within a corresponding channel that is different than a carrier optical frequency and corresponding channel of each of other N-1 different lasers of the N lasers;
wherein each of the plurality of WDM transceivers is coupled to one of Y optical fibers, wherein an output of each of the plurality of WDM transceivers is transmitted over a corresponding one of the Y optical fibers when the corresponding one of the Y optical fibers is operational;
a plurality of bit source devices, each of the plurality of bit source devices generating a plurality of bit streams;
wherein each of the plurality of bit streams of each of the bit sources is selectively connected to an input of one of the plurality of WDMs and modulated onto a one of the N carriers signals of the one of the plurality of WDMs for communication across a corresponding one of the Y optical fibers, wherein at least one of the bit streams of one of the plurality of bit source devices is communicated across a different one of the Y optical fibers than another one of the bits streams of the one of the plurality of bit source devices.

2. The optical system of claim 1, further comprising
a reconfigurable switch configured to receive each of the plurality bit streams of each of the plurality of bit source devices, wherein the plurality bit streams includes up to Y×N bit streams and connect each of the up to Y×N of the plurality of input streams to outputs of the reconfigurable switch, wherein each of the outputs of the reconfigurable switch is connected to at least one modulator of one of the plurality of WDMs for modulation on a selected one of N×Y carrier signals;
a controller, the controller configured to adaptively select switch connections of the reconfigurable switch to enable selection of which of the plurality input bit streams of which of the plurality of bit source devices is communicated over which carrier signals of which of the Y optical fibers.

3. The optical system of claim 1, wherein conductors provide the mapping between each of the plurality of input streams are mapped to each of the modulators for communication over a corresponding one of the Y optical fibers.

4. The optical system of claim 2, comprising:
an optical reception system, comprising:
Y optical receiver systems, each of the Y optical receiver systems configured to receive and demodulate a corresponding optical communication signal resulting in received bit streams;
a second reconfigurable switch configured to receive the received bit streams and connect each of the received bit streams to outputs of the second reconfigurable switch.

5. The optical system of claim 4, wherein the plurality input bit streams received by the reconfigurable switch match the received bit streams at outputs of the second reconfigurable switch.

6. The optical system of claim 4, wherein the controller is further configured to control the reconfigurable switch and the second reconfigurable switch to connect the input bit streams over optical fibers that are operational, thereby avoiding non-operational optical fibers.

7. The optical system of claim 4, wherein the controller is further configured to:
determine non-operational optical fibers; and
control the reconfigurable switch and the second reconfigurable switch to connect the input bit streams over optical fibers that are operational, thereby avoiding the non-operational optical fibers.

8. The optical system of claim 4, wherein the optical transmission system is a part of a first transceiver and the optical receiver system is a part of a second transceiver, and the controller is configured to adaptively direct bit streams back and forth over operational of the Y optical fibers.

9. The optical system of claim 1, wherein each of the WDM transceivers comprise:
M different selectable lasers, each of the M different lasers configured to generate an optical communication signal having a carrier optical frequency within a corresponding channel that is different than a carrier optical frequency and corresponding channel of each of other M-1 different lasers of the M lasers;
wherein the controller is further configured to select and map N of the M selectable lasers based on feedback regarding a quality of one or more of the M different lasers, wherein N<M; and
a switch selector configured to select the N of the M selectable lasers for transmission over an optical fiber to a second optical receiver system.

10. The optical transmitter system of claim 9, wherein M is selected based on at least a projected end of life of the M different selectable lasers.

11. The optical transmitter system of claim 9, wherein the N selected lasers are selected based on a signal quality of each of the transmission signals of each of the M lasers.

12. The optical transmitter system of claim 9, wherein the N selected lasers are selected from the M lasers based on an estimated BER (bit error rate) of N modulated carrier signals.

13. A method of an optical system, comprising:
generating, by each of N lasers of each of a plurality of wave-division-multiplexing (WDM) transceivers of an optical transmission system, an optical communication signal having a carrier optical frequency within a corresponding channel that is different than a carrier optical frequency and corresponding channel of each of other N-1 different lasers of the N lasers;
coupling each of the plurality of WDM transceivers to one of Y optical fibers, wherein an output of each of the WDM transceivers is transmitted over a corresponding one of the Y optical fibers when the corresponding one of the Y optical fibers is operational;
receiving, by each of modulators of the WDM transceivers, N bit streams of a plurality of input streams;
modulating the optical communication signal of each of the N lasers with corresponding N bit streams;
receiving, by a reconfigurable switch, the plurality input bit streams;
generating, by each of a plurality of bit source devices, a plurality of bit streams; and
selectively connecting each of the plurality of bit streams of each of the bit sources to an input of one of the plurality of WDMs for modulation onto the N carriers signals of the one of the plurality of WDMs for communication across a corresponding one of the Y optical fibers, wherein at least one of the bit streams of one of the plurality of bit source devices is communicated across a different one of the Y optical fibers than another one of the bits streams of the one of the plurality of bit source devices.

14. The method of claim 13, wherein a reconfigurable switch performs the selective connecting, comprising:
receiving, by the reconfigurable switch, each of the plurality bit streams of each of the plurality of bit source devices, wherein the plurality bit streams include up to Y×N bit streams;
connecting, by the reconfigurable switch, each of the up to Y×N of the plurality of input streams to outputs of the reconfigurable switch, wherein each of the outputs of the reconfigurable switch is connected to at least one modulator of one of the plurality of WDMs for modulation on a selected one of N×Y carrier signals;
adaptively selecting, by a controller, switch connections of the reconfigurable switch to enable selection of which of the plurality input bit streams of which of the plurality of bit source devices is communicated over which carrier signals of which of the Y optical fibers.

15. The method of claim 13, wherein conductors provide mapping between each of the plurality of input streams are mapped to each of the modulators for communication over a corresponding one of the Y optical fibers.

16. The method of claim 14, comprising:
receiving and demodulating, by each of Y optical receiver systems, a corresponding one of optical communication signals resulting in received bit streams;
receiving, by a second reconfigurable switch, the received bit streams and connecting each of the received bit streams to outputs of the second reconfigurable switch.

17. The method of claim 16, further comprising:
controlling, by the controller the reconfigurable switch and the second reconfigurable switch to connect the input bit streams over optical fibers that are operational, thereby avoiding non-operational optical fibers.

18. The method of claim 16, further comprising:
determining non-operational optical fibers; and
controlling, by the controller, the reconfigurable switch and the second reconfigurable switch to connect the input bit streams over optical fibers that are operational, thereby avoiding the non-operational optical fibers.

19. The method of claim 16, wherein the optical transmission system is a part of a first transceiver and the optical receiver system is a part of a second transceiver, and the controller is configured to adaptively direct bit streams back and forth over operational of the Y optical fibers.

20. The method of claim 13,, wherein each of the WDM transceivers comprises M different selectable lasers, each of the M different lasers configured to generate an optical communication signal having a carrier optical frequency within a corresponding channel that is different than a carrier optical frequency and corresponding channel of each of other M-1 different lasers of the M lasers; and further comprising:
selecting and mapping, by the controller, N of the M selectable lasers based on feedback regarding a quality of one or more of the M different lasers, wherein N<M; and
selecting, by a switch selector, the N of the M selectable lasers for transmission over an optical fiber to a second optical receiver system.
